(19) United States
(12) Patent Application Publication
(10) Pub. No.: US 2014/0251576 A1
(43) Pub. Date: Sep. 11, 2014

(54) ADJUSTABLE FURNACE MOUNTING SYSTEM

(71) Applicant: Christopher Williams, Riverside, CA (US)

(72) Inventor: Christopher Williams, Riverside, CA (US)

(21) Appl. No.: 14/199,705

(22) Filed: Mar. 6, 2014

Related U.S. Application Data
(60) Provisional application No. 61/773,420, filed on Mar. 6, 2013.

(51) Int. Cl. F27D 1/14

(52) U.S. Cl. CPC F27D 1/14
USPC 165/64; 248/157

(57) ABSTRACT

An assembly for mounting a replacement heater with an air conditioner unit. The assembly includes a base member that defines an opening and is mounted on the floor. The assembly further includes a telescoping member that extends out of the opening over a range of positions so that replacement heaters of different sizes can be positioned and maintain proximate the air conditioner unit.

### BACKGROUND OF THE INVENTION

1. Field of the Invention

The present invention relates to a system for mounting furnaces and, in particular, concerns a structure for adjustably receiving a replacement furnace that allows a smaller replacement furnace to be mounted in a larger space while reducing the need to relocate other heating and air conditioning components.

2. Description of the Related Art

Combined heating and air conditioning systems are often comprised of a furnace and an air conditioning system. In a typical home or building unit, the air conditioning system includes a compressor and hot tube assembly that is located outside of the house or building with an air conditioning component including chilled coils on the inside of the building. The air conditioning component receives compressed air conditioning liquid, such as Freon, from the exterior compressor. Air is blown over the chilled coils and then exhausted into the ducting system of the building to cool the building.

In many homes and small building applications, the air conditioning component is mounted on top of the furnace component and the blower system of the heating unit can be used to blow air over the chilled coils to provide air conditioning to the interior of the house. However, when older furnaces are being replaced they are often being replaced with smaller sized heating units which can require relocation of the air conditioning component.

For example, older furnaces have a height that can be within the range of 42 to 48 inches tall. Newer furnaces are often in the range of 33.5 inches in height. Thus, when an older furnace is being replaced, the newer furnace may not be tall enough to contact the bottom surface of the air conditioning unit leaving the air conditioning unit unsupported. Further, a gap between the furnace and the air conditioner reduces the ability of the furnace fan to blow the air conditioned air into the ducting system of the building.

These problems often require an installer to move the air conditioner when the existing furnace is being replaced by a smaller unit. This typically requires re-running Freon tubes, doing additional welding and remounting the air conditioning unit. Often, replacing a furnace unit can turn into a full day job largely as a result of the need to move and reinstall the air conditioning component.

Hence, there is a need for a system that allows for the replacement of existing furnaces with smaller furnaces that doesn't require remounting or reinstallation of the air conditioning component.

### SUMMARY OF THE INVENTION

The aforementioned needs are satisfied by the furnace and air conditioning mounting system of the present invention. In one non-limiting embodiment, the system comprises an adjustable mounting structure that is mounted on the floor, wherein the height of the mounting structure is adjustable so that a furnace unit with a smaller height can be positioned on the mounting structure and the height of the mounting structure is adjusted so that the furnace unit is in contact with the air conditioning component.

In one specific example, the adjustable mounting structure comprises a box that includes a base and a telescoping top that is positioned within an interior space defined by the base. The telescoping top is preferably telescoped outward of the base a distance sufficient such that, when the replacement furnace is mounted on the telescoping top, the furnace is positioned proximate the existing air conditioning component. The telescoping top is then secured in the extended orientation. In one implementation, the telescoping top can be secured in the extended orientation by screwing screws or other fasteners through the telescoping top and the base to secure the telescoping top in the extended orientation.

In one specific example, the base may also include a filter rack that can receive an air filter. The base may also include a filter door that allows for the filter to be removed for cleaning purposes. In one specific example, the filter rack is positioned at the bottom of the base.

It will be appreciated that the dimensions of the adjustable mounting structure can vary without departing from the scope of the present invention. The mounting structure is described as a box but can be any of a number of different configurations depending upon the implementation. Further, the dimensions of the base will also vary depending upon the size of the furnace unit that is being installed. Larger furnaces may require larger mounting structures. The attached drawings show various implementations and dimensions for typical furnace installations, however, it will be appreciated that these dimensions are simply examples of the possible sizes.

The use of the expandable mounting structure means that a smaller furnace can be installed in the place of a larger existing furnace and the expandable mounting structure can be expanded so that the furnace is positioned proximate the air conditioning component. This reduces or potentially eliminates the need to relocate or reinstall the air conditioning component which greatly simplifies the replacement of existing furnaces with smaller furnaces.

These and other objects and advantages will become more apparent from the following description taken in conjunction with the accompanying drawings.

### BRIEF DESCRIPTION OF THE DRAWINGS

FIGS. 1A and 1B are assembled and exploded views of the adjustable mounting structure with the base and telescoping top for a furnace and air conditioner assembly;

FIG. 2 is a top view of the mounting structure of FIGS. 1A and 1B;

FIGS. 3A-3C are front elevational drawings illustrating the mounting of a furnace using the mounting structure of FIGS. 1A and 1B.

### DESCRIPTION OF ONE EMBODIMENT

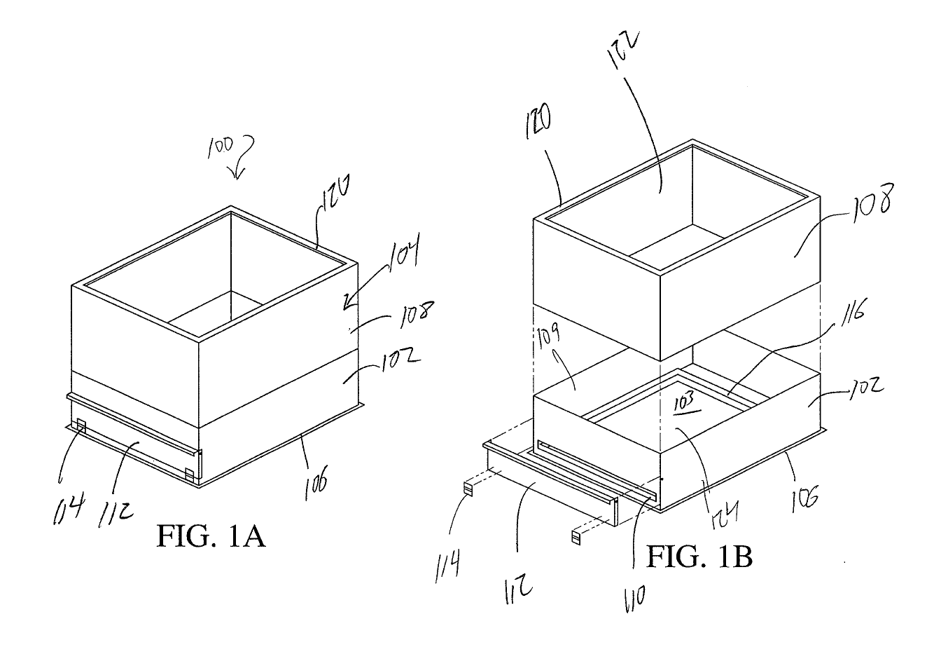

Reference will now be made to the drawings, wherein like numerals refer to like parts throughout. FIGS. 1A and 1B illustrate a mounting structure 100 that is used to mount a replacement furnace with an existing air conditioner in such a manner that relocation of the air conditioner and the associated wiring and piping is reduced.

As shown, the structure 100 includes a base 102 that is generally rectangular in shape but can be other shapes without departing from the scope of the present invention. The base 102 defines an interior space 103 that receives a telescoping member 104. The telescoping member 104 is sized so that the outer side walls 108 of the telescoping member are flush with the inner side walls 109 of the base member 102. As will be described in greater detail below, the telescoping member 104 extends upwards from the base to support a heater assembly at a mounting level that reduces the need to remount an air conditioner unit. The telescoping member 104 and the base member 102 can be sized depending upon the size of the furnace member and the mounting height of the air conditioner unit as will be described in greater detail below.

As is also shown in FIGS. 1A and 1B, the base member 102 includes a flange 106 that permits stable mounting on the ground. In this implementation, the flange 106 extends about the entire outer perimeter of the walls of the base member 102. The size of the flange 106 can also vary depending upon the implementation without departing from the scope of the present invention.

The base member 102 also includes a filter opening 110 that, in this implementation, comprises a flat rectangular opening that is sized to receive a standard heater filter. The filter opening is accessible via a hinged door 112 that is mounted to the walls of the base member 102 via hinges 114 in a well-known manner. The hinged door 112 permits easy access to the filter for cleaning and replacement.

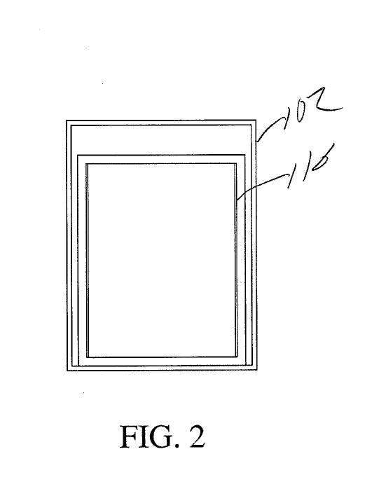

The telescoping member 104 also defines an inwardly extending flange 120 that extends into an opening 122 of the telescoping member 104. The flange 120 forms a mounting surface that receives a heater unit in the manner that will be described in greater detail below. The flange 120 is preferred as the heater preferably draws air through an opening 124 in the bottom of the base unit 102 which is then drawn through the filter in a known manner. Referring to FIG. 2, the base member 102 includes a flange 116 that receives the filter member. The flange 116 preferably positions the filter above the ground which allows air to be drawn through the filter. The flange 116 may also define a bottom surface for the telescoping member 104 to rest upon prior to the telescoping member 104 being extended for deployment to receive a heater in the manner that will be described in greater detail below.

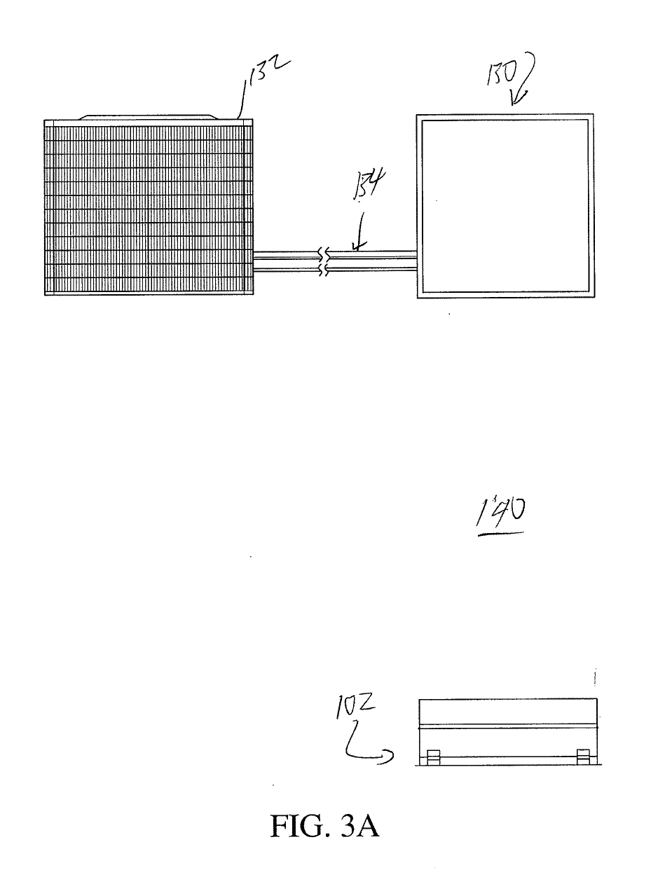

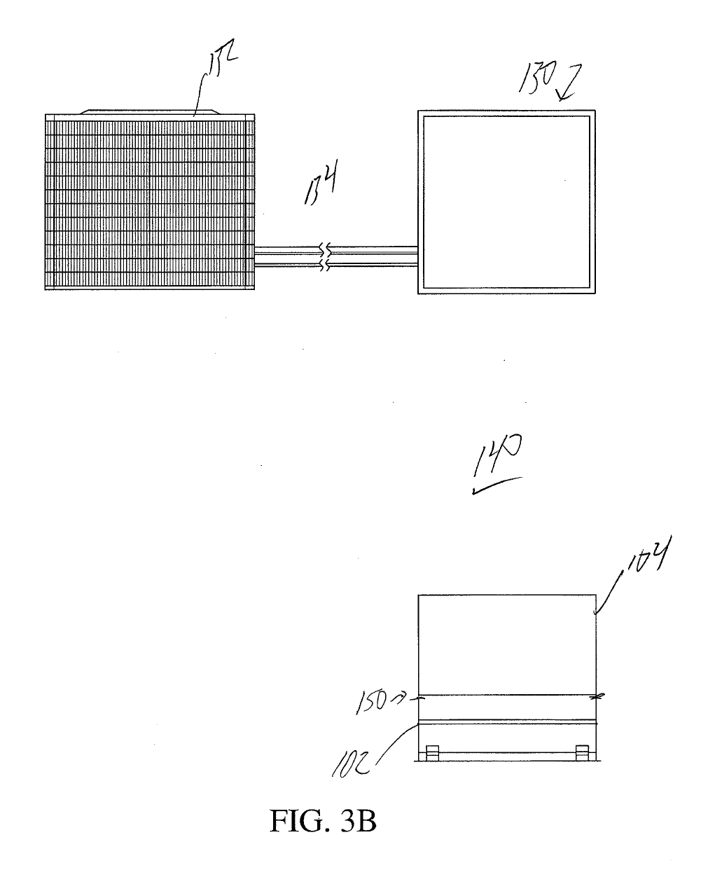

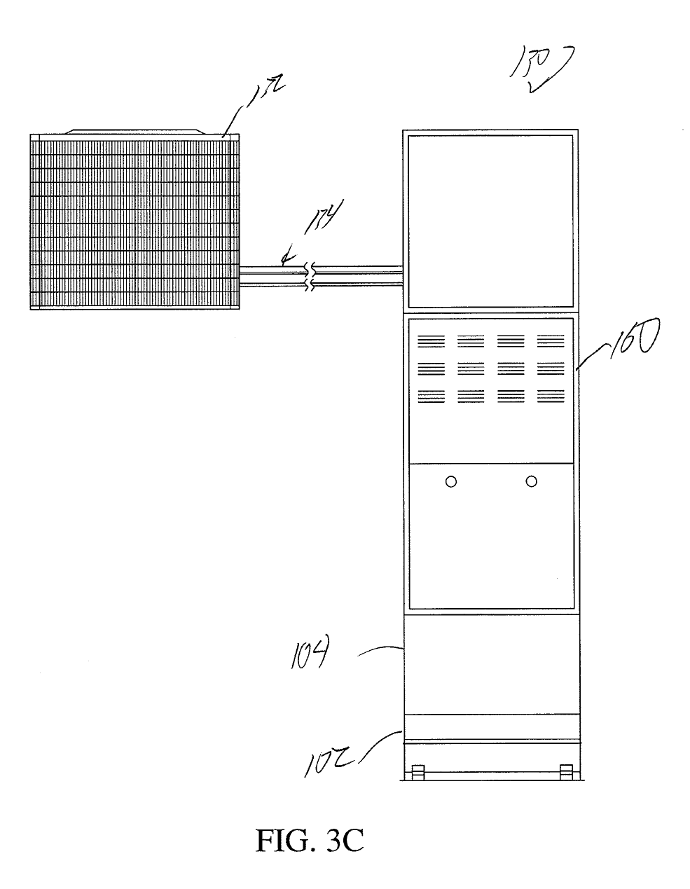

FIGS. 3A-3C illustrate an exemplary use of the assembly 100. As shown, there is an air conditioner unit 130 that has cooled coils and is preferably wall mounted at a first height in a well-known manner. The air conditioner unit 130 is coupled to an external compressor 132 via piping, etc. 134 also in a well-known manner. The air conditioner unit 130 and the compressor 132 can be any of a number of well-known and commonly available units that are currently on the market today. The air conditioner unit 130 is preferably mounted to a wall in a well-known manner and is connected to the internal air supply ducting of the building which can comprise a house, workspace, storage space, etc.

In FIG. 3A, a heater unit has been removed and a replacement heater unit that is smaller in the height direction than the original heater unit is being installed in the space 140. A base unit 102, such as the unit described above, is mounted on the floor underneath the space 140. The base unit 102 provides a stable mounting platform for both the telescoping member 104 and the heater unit as will be described below.

As shown in FIG. 3B, the telescoping member 104 is then positioned within the opening 124 of the base member 104. The telescoping member 104 can then be extended to a desired height and secured at the desired height via fasteners 150. The fasteners 150 can be screws that extend through the walls of the telescoping member 104 and the base member 102 so as to secure the flange 120 of the telescoping member 102 at the desired height.

As shown in FIG. 3C, a heater 160 can then be mounted on the flange 120 of the telescoping member 104 so that the space 140 is filled with the telescoping member 104 and the heater 160. The heater 160 is preferably connected to the air conditioner 130 in a well-known manner such that air that is blown by the heater can be blown past the cooling coils of the air conditioner unit 130 in a known manner.

Advantageously, the telescoping member 104 can be adjusted to a range of different heights to accommodate different sizes of heaters. Thus, smaller heaters can be used to replace existing larger heaters and the smaller heaters can be positioned in proximity to the bottom of the air conditioner unit 130. In this way, smaller heaters can be used as replacement heaters with the heaters mounted adjacent the air conditioning units without requiring the relocation of the air conditioner unit. As discussed above, relocation of the air conditioner unit can result in expensive relocation of wiring and piping which can significantly increase the cost of installing replacement heater.

The exact dimensions of the base unit 102 and the telescoping unit 104 can vary depending upon the implementation. However, in one exemplary, non-limiting embodiment, the base unit is roughly 28 9/16″ long with a width that varies depending upon the weight of the air conditioning unit. For a currently available standard 1 to 3 ton unit, the width is 15 9/16″, for a 4 ton unit, the width is 17 11/16″ and for a 5 ton unit the weight is 21 9/16″. The filter flange or rack 116 has, in this embodiment, a length of 25″ and a width of 14″ for a 1 to 3 ton unit, 16″ for a 4 ton unit and 20″ for a 5 ton unit. The filter housing can be sized to accommodate filters that are 1″, 2″ or 4″ in thickness. The base member 102 and telescoping member 104 are preferably made of sheet steel that is ¼″ thick.

The base member is preferably 8″ high and the telescoping member 104, in one embodiment, is up to 30″ to 33½″ tall and can be secured to the base member 102 so as to allow a range of positions of the heater member 160 at 42″ to 48″ above the ground. Again these dimensions can vary without departing from the spirit or scope of the present invention.

The foregoing discussion has shown, described and illustrated various embodiments of the present invention as well as the uses thereof. It will be appreciated, however, that various changes, modifications and substitutions to the above-described embodiments, as well as the uses thereof, may be made by those skilled in the art without departing from the sprit or scope of the present invention. Hence, the present invention should not be limited to the foregoing discussion but should be defined by the appended claims.

What is claimed is:

1. An assembly for mounting a heater so as to be positioned adjacent an air conditioner unit, the assembly comprising:
a base member that is sized to be positioned on the floor wherein the base member defines an inner opening;
a telescoping member that is positioned within the inner opening of the base member and is vertically adjustable thereto, wherein the telescoping member defines an upper surface that receives the heater and the telescoping member is adjustable with respect to the base member so that the heater is positionable at a range of different heights; and
at least one securing member that secures the telescoping member at a first height.

2. The assembly of claim 1, wherein the base member comprises a rectangular member.

3. The assembly of claim 2, wherein the base member includes a flange that is positioned on the floor.

4. The assembly of claim 1, wherein the base member defines a filter flange positioned within the inner opening that is sized to receive a filter.

5. The assembly of claim 4, wherein the base member includes an opening that is sized to receive a filter to be positioned on the filter flange.

6. The assembly of claim 5, comprises a hinged door positioned on the base member that covers the opening in the base member sized to receive a filter.

7. The assembly of claim 1, wherein the telescoping member comprises a member that defines an inner opening that mates with the inner opening of the base member to allow air therethrough.

8. The assembly of claim 7, wherein the telescoping member is rectangular in shape.

9. The assembly of claim 1, wherein the base member is approximately 28 9/16″ long by approximately 15 9/16″ to 21 9/16″ wide by approximately 8″ tall and the telescoping member is adjustable over a range of 30″ to 40″.

10. The assembly of claim 1, wherein the telescoping member is flanged.

11. A heating and air conditioning mounting assembly comprising:
an air conditioner unit that is mounted to a wall;
a base member that is mounted to the floor so that there is a space between the air conditioner unit and an upper surface of the base member;
a heater unit that is positioned adjacent to a bottom surface of the air conditioning unit; and
an extending unit that is positioned within the base unit and is extendable over a range so that the heater is positioned in the first position and the space between the air conditioning unit and the upper surface of the base member is occupied by the heater unit and the extending member.

12. The assembly of claim 11, wherein the base member includes a flange that is positioned on the floor.

13. The assembly of claim 11, wherein the base member defines a filter flange positioned within the inner opening that is sized to receive a filter.

14. The assembly of claim 13, wherein the base member includes an opening that is sized to receive a filter to be positioned on the filter flange.

15. The assembly of claim 14, comprises a hinged door positioned on the base member that covers the opening in the base member sized to receive a filter.

16. The assembly of claim 11, wherein the extending member comprises a member that defines an inner opening that mates with the inner opening of the base member to allow air therethrough.

17. The assembly of claim 16, wherein the extending member is rectangular in shape.

18. The assembly of claim 11, wherein the base member is approximately 28 9/16″ long by approximately 15 9/16″ to 21 9/16″ wide by approximately 8″ tall and the extending member is adjustable over a range of 30″ to 40″.

19. The assembly of claim 11, wherein the extending member is flanged.

20. The assembly of claim 11, wherein the base member comprises a rectangular member.
